(19) United States
(12) Patent Application Publication
(10) Pub. No.: US 2009/0184094 A1
(43) Pub. Date: Jul. 23, 2009

(54) LASER ASSEMBLY WITH ELECTRONIC MASKING SYSTEM

(75) Inventors: Ulrich GUBLER, Ruthvenz (CH); Reto ZURBUCHEN, Luzern (CH)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(73) Assignee: LEISTER PROCESS TECHNOLOGIES, Kagiswil (CH)

(21) Appl. No.: 12/354,817

(22) Filed: Jan. 16, 2009

(30) Foreign Application Priority Data
Jan. 17, 2008 (DE) 20 2008 000 723.2

(51) Int. Cl. B23K 26/00

(52) U.S. Cl. 219/121.63

(57) ABSTRACT

The invention concerns a laser assembly for processing or joining work pieces by means of electromagnetic radiation, with a laser source that emits a laser beam, and an electronic masking system for the work pieces that succeeds the laser source. The masking system images the passing laser beam on the work pieces in a pattern that is randomly selectable. As masking system, a phase modulation array with preferably a common pixel size >4 μm is used, and also a laser source with a high beam quality of the laser beam that together permit the sharp imaging of patterns with a line width <2 mm on the work pieces.

### TECHNICAL FIELD OF THE INVENTION

The invention concerns a laser assembly for processing or joining work pieces by means of electromagnetic radiation, with a laser source that emits a laser beam, and an electronic masking system for the work pieces that succeeds the laser source, with the masking system imaging the passing laser beam on the work pieces in a pattern that is randomly selectable.

### DESCRIPTION OF THE RELATED ART

When processing or joining work pieces with electromagnetic radiation, specifically with a laser beam, the size and the shape of the beam profile focused on the work pieces play an important role. During laser processing, correct selection of the power density distribution within the generated focal spot is also important. With laser beam welding, for example with transmission welding of plastic materials, it is often necessary to generate heat distribution patterns or welding seams of many different shapes.

As a rule, laser sources have a round beam cross-section that needs to be transformed to the desired size and the required shape by means of suitable measures. On the one hand, this may be accomplished with special optical systems or masks that are tailored to the specific task but take a long time to produce and are not, or not easily, modifiable in most cases. On the other hand, a method is known whereby, in the interest of more flexibility and therefore a higher degree of usefulness, the laser beam is transformed by means of an electronic position-sensitive beam modulator that is capable of changing the amplitude and/or the polarization and/or the phase of the laser light. Laser systems with such an electronic beam modulator are disclosed, for example, in the disclosures DE 100 07 391 A1 and DE 10 2004 017 129 A1.

DE 100 07 391 A1 concerns a device and a process for material processing with electromagnetic radiation. By using the electronic position-sensitive beam modulator, the device generates a pre-selectable power density distribution within a focal spot on the work piece. The position-sensitive modulation of the radiation permits a sequential as well as a simultaneous processing of the work pieces, and also a quasi-simultaneous processing mode.

DE 10 2004 017 129 A1 describes a laser imaging device with a laser beam emitting laser source and an electronic display device. The display device succeeds the laser source at the exit side. It serves to polarize individual sections of the laser beam in order to define modified and non-modified sections. A polarization filter succeeds the display device in order to prevent, as desired, the passage of modified and the non-modified sections of the laser beam so that an imaging beam with a pre-defined cross-sectional pattern is generated.

In the prior art referred to above, assemblies of liquid crystals are preferably used as beam modulators or display units. The liquid crystals are enclosed in individually controllable liquid crystal cells that are ideally arranged flat next to each other in a regular pattern. In this manner, the cells form an array of individual single modulators. A laser beam section impinging upon the liquid crystal cells is modulated within the cell by means of controlled modulation making use of electro-optical effects.

Modulation arrays formed by liquid crystal cells can be used for modulating the phase of the impinging laser light and/or its amplitude. Compared with amplitude modulation, phase modulation makes better use of the energy of the laser beam because no radiation portions of the original non-modulated laser beam are masked. Due to the spatial modulation of the phase of the laser light, the phase modulation array acts as a diffractive optical element (DOE).

The currently available phase modulation arrays have relatively large pixels of between 5 and 10 micrometers. Common laser sources generate laser radiation with a typical wavelength of several hundred nanometers. According to the law of diffraction, this leads to small maximum deflection angles of approximately 5 to 10 degrees for the deflection of the laser light. The deflection angle has a large influence on the sharpness of the beam pattern generated on the work pieces by the phase-modulated laser beam. It was found that high-energy laser light put out by high-power diode lasers or Nd-YAG solid state lasers is capable of sharply imaging only lines with a width of several millimeters on the work pieces when the usual distance between the processing head of the laser device and the work pieces is used. Frequently, however, it is desirable or necessary to generate narrower patterns with a high energy density and sharp edges on the work pieces.

In view of the aforementioned shortcomings, there is a strong need in the art for a device that is specifically capable of sharply imaging lines of narrower width on the work pieces.

### SUMMARY OF THE INVENTION

According to one aspect of the invention, a laser assembly is provided for processing or joining work pieces by means of electromagnetic radiation, with a laser source that emits a laser beam, and an electronic masking system for the work pieces that succeeds the laser source, with the masking system imaging the passing laser beam on the work pieces in a pattern that is randomly selectable, wherein, by a phase modulation array as masking system, with a common pixel size larger than four micrometers, and a laser source with a high quality of the laser beam that permits the sharp imaging of patterns with a line width smaller than two millimeters on the work pieces.

According to a particular aspect, the invention focuses the laser beam more sharply on the work pieces without additional optical aids after the phase modulation array. It was found that the sharpness of a beam pattern on the work pieces is not only determined by the diffraction of the laser beam that is dependent on the pixel size of the phase modulation array and the wavelength of the laser light used, but also by the angle of departure of the laser source for the laser beam. The divergence of the laser beam, i.e. its widening with increasing distance after exiting from the laser source, is a measure of the quality of a laser and of the quality of its beam. A smaller divergence with a small beam diameter means good beam quality and leads to a sharper image.

The focusability of laser radiation is described by the diffraction coefficient M² according to the ISO Standard 11146. This coefficient indicates the divergence angle in relation to the divergence of an ideal Gauss beam with the same waist diameter of the beam.

In accordance with another aspect, the laser assembly according to the invention therefore has a phase modulation array with a common pixel size of larger than 4 micrometers, preferably of four to ten micrometers, and a laser source with a laser beam of high quality. The proposed combination of a laser source with high beam quality with a phase modulation array with a limited minimum pixel size makes it possible to produce sharp images of lines with a line width of less than two millimeters on the work pieces by means of laser light. The phase modulation array may be operated in familiar fashion in a transmissive or reflective mode.

Preferably, a laser source is used for this purpose that puts out laser radiation with a beam quality K>0.5, which is therefore associated with a diffraction coefficient of M²<2.

These especially advantageous properties are offered by laser radiation generated by a fiber laser. Such fiber lasers combine in excellent fashion the advantages of diode-pumped solid state lasers with those of wave conductors. The light conductance in the core area of the fiber permits high power densities over the entire fiber length and high output power simultaneously with excellent beam quality. High-power fiber lasers are able to emit wavelengths of several micrometers, which produces a distinctly smaller deflection angle.

In particular, the laser assembly according to the invention is an excellent tool for transmission welding of work pieces made of plastic material. It permits the use of the phase modulation array as a variable diffractive optical element for the production of samples or small production runs. It is therefore especially advantageous and practical for frequent change-over processes because it significantly reduces the necessary set-up time.

Advantageously, the masking system is able to image the laser beam in a fixed location as a fixed pattern, or as a moving pattern in variable locations on the work pieces. In this way, the laser assembly according to the invention is equally well suited for the simultaneous as well as the quasi-simultaneous processing or joining of work pieces. Accordingly, besides a standard use for simultaneous welding, the variably controllable phase modulation array can also be used as scanner. For this purpose, a sawtooth-like spatial modulation is generated that effects a deflection of the entire impinging laser beam. In this mode, the laser assembly can also be used for contour welding.

The phase modulation has the purpose of modulating the phase of the laser light in such a way that a desired interference pattern is generated. Starting with a polarized radiation field with sufficient transversal coherence, the phase relationships of individual sub-sections of the impinging laser beam are changed in a controlled manner so that the sub-sections interfere in the desired manner after the phase modulation array. The liquid crystal cells divide the impinging laser beam into individual partial-beam bundles. Each of the partial-beam bundles is then phase modulated in a certain way in the individually controllable cells. After exiting from the phase modulation array, the individual partial beams as a whole form a new laser beam. Thus, the modulation of a partial-beam bundle determined by the liquid crystal cell associated with it is especially simple and flexible and, above all, independent of the other partial-beam bundles.

The position sensitivity and therefore also the sharpness of the pattern imaged on the work pieces is primarily determined by the beam quality of the original radiation field and by the geometry and the number of the individual liquid crystal cells. In practical terms, the refractive index of the liquid crystals can be altered by an electric voltage that is generated by a suitable electronic control device and is applied to the liquid crystal cell. This, in turn, makes it possible to influence the phase relationship of the impinging laser light. With increasing voltage, the refractory index and thereby the optical phase delay can be altered continuously. The controlled application of individual voltages to certain selected liquid crystal cells of the phase modulation array produces a multitude of individual phase relationships. The controlled modulation of the phases of the individual partial-beam bundles results in their interfering on the work pieces to produce the desired pattern.

In principle, instead of a phase modulation array based on liquid crystals, a microelectro-mechanical system with vertically moving mirrors (MEMS) can also be used.

To the accomplishment of the foregoing and related ends, the invention, then, comprises the features hereinafter fully and particularly pointed out in the claims. The following description and drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Below, the invention is explained in detail with reference to an embodiment thereof. It concerns a laser assembly with a variable phase modulation array for laser transmission welding of work pieces. In a schematic view,

FIG. 1 shows a laser assembly according to the invention for the simultaneous welding operating mode; and

FIG. 2 shows a beam deflection from the laser assembly in FIG. 1 in the quasi-simultaneous welding or contour welding operating mode.

### DETAILED DESCRIPTION OF THE INVENTION

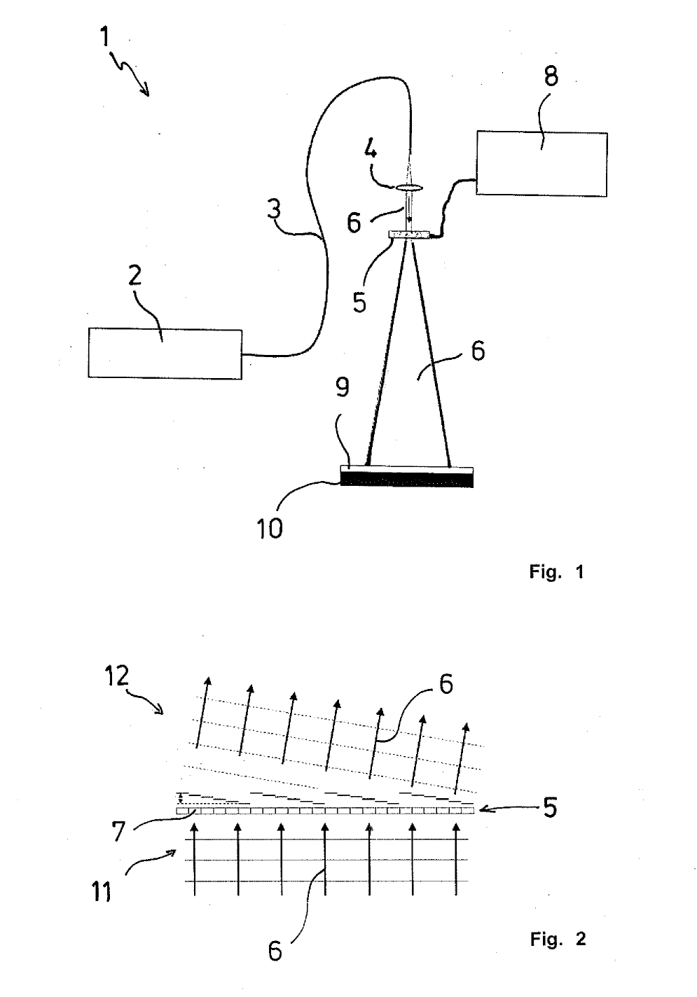

FIG. 1 shows the laser assembly 1 according to the invention, comprising a fiber laser 2, a fiber-optic conductor 3 leading to a processing head (not shown) in which an optical lens 4 for forming the beam and a phase modulation array 5 for the phase modulation of the radiation of a laser beam 6 are located. The laser beam 6 exiting from the optic conductor 3 is bundled by the lens 4 and projected onto the liquid crystal cells 7, shown in FIG. 2, of the phase modulation array 5.

The liquid crystal cells 7 of the phase modulation array 5 can be controlled individually and independent of each other by means of an electronic control system 8, and modulate the phases of the impinging laser beam 6 at certain locations in a pre-selected manner as desired in an identical and/or different way. In the embodiment shown here, the phase modulation array 5 is operated in transmission so that the laser beam 6 passes the liquid crystal cells 7, which generates a certain beam pattern that is guided simultaneously to the work pieces 9, 10 to be joined.

FIG. 2 shows the deflection of the laser beam 6 without formation of a special pattern. Here, the liquid crystal cells 7 arranged next to each other are controlled by the control system 8 in such a way that the laser beam 6 experiences a sawtooth-like spatial phase modulation that leads to a continuous beam deflection of the beam 6. In front of the entry side 11 and after the exit side 12 of the phase modulation array 5, the light waves of the laser beam 6 travel in different directions, due to the changed phase relationship.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A laser assembly for processing or joining work pieces by means of electromagnetic radiation, including a laser source that emits a laser beam, and an electronic masking system for the work pieces that succeeds the laser source, with the masking system imaging the passing laser beam on the work pieces in a pattern that is randomly selectable, wherein, by a phase modulation array as masking system, with a common pixel size larger than four micrometers, and a laser source with a high quality of the laser beam that permits the sharp imaging of patterns with a line width smaller than two millimeters on the work pieces.

2. A laser assembly according to claim 1, wherein the beam quality K of the laser radiation has a value larger than 0.5 and that the diffraction coefficient M² has a value of smaller than 2.

3. A laser assembly according to claim 1, wherein the laser source is a fiber laser.

4. A laser assembly according to claim 1, wherein the masking system images the laser beam in a fixed location as a fixed pattern on the work pieces.

5. A laser assembly according to claim 1, wherein the masking system images the laser beam as a moving pattern on the work pieces.

6. A laser assembly according to claim 2, wherein the laser source is a fiber laser, and
masking system images the laser beam in a fixed location as a fixed pattern on the work pieces.

7. A laser assembly according to claim 3, wherein the laser source is a fiber laser, and
masking system images the laser beam in a fixed location as a fixed pattern on the work pieces.

8. A laser assembly according to claim 2, wherein the masking system images the laser beam as a moving pattern on the work pieces.

9. A laser assembly according to claim 3, wherein the masking system images the laser beam as a moving pattern on the work pieces.
